(19) United States
(12) Patent Application Publication
(10) Pub. No.: US 2005/0253707 A1
(43) Pub. Date: Nov. 17, 2005

(54) Locating system, device and method

(76) Inventors: Roger Edwin Clarke, Berkshire (GB); Linda Joyce Clarke, Berkshire (GB); Simon Giles Clarke, Berkshire (GB); Peter John Lillie, Berkshire (GB); Terence James Blaney, Buckinghamshire (GB)

Correspondence Address: Theodore D Lienesch;Thompson Hine, 2000 Courthouse Plaza NE, 10 West Second Street, Dayton, OH, 45402-1758, US

(21) Appl. No.: 10/524,597

(22) PCT Filed: Aug. 12, 2003
(86) PCT No.: PCT/GB03/03510

§ 371 Date: Feb. 15, 2005

(30) Foreign Application Priority Data
Aug. 15, 2002 (GB) 0219006.4

(51) Int. Cl. G08B 1/08

(52) U.S. Cl. 340/539.15; 340/573.1

(57) ABSTRACT

A locating system is disclosed, which can be used for locating a child. The system comprises a child locating device (parent unit) and a further device (child unit) carried or worn by the child. The child unit transmits an electromagnetic signal towards the parent unit, and the parent unit receives the electromagnetic signal, using at least three spaced antennas which are switched in such a way as to obtain a Dopplescant effect. The received signal is processed and the direction of the child unit with respect to the parent unit is displayed on a display on the parent unit. Distance measurement is also possible. The system can be used with several child units.

The present invention relates to a locating system, a locating device for use in that system and a locating method.

The present invention finds particular application in a technique for locating a child wearing or carrying a suitable device, but not all embodiments of the present invention are limited to a child locating technique. It will be appreciated that the invention can also be used for locating persons other than children, animals or indeed objects equipped with a suitable device. However, for the sake of simplicity the present invention will be described with particular reference to a child locating technique.

Various techniques are known which enable a parent (or guardian) to monitor the position, direction or distance of a device worn or carried by a child with respect to a device operated by the parent.

For the purpose of the discussion of the prior art and the description of the present invention the device operated by the parent will be referred to as the “parent unit”, and the device carried or worn by the child will be referred to as the “child unit”. The term “locating device” as used in the appended claims covers, inter alia, the parent unit, and the term “further device” used in the appended claims covers, inter alia, the child unit.

U.S. Pat. No. 6,075,442 discloses a child locator system having three narrow beam antennas arranged at three sides of a parent unit. Visual indicators are associated with each of the antennas. The strength of any signal received from a child unit is detected by each antenna, and the associated indicators are illuminated in correspondence with the received signal strength. This is used as an indication of the direction from which the radio signals emanate, i.e. the direction of the child unit.

Several disadvantages are associated with this known system. Firstly, the detected signal strength cannot provide a reliable indication of the distance between the parent unit and the child unit. Secondly, if the child unit is not within one of the narrow angular ranges of the parent unit antennas then no (reliable) reading will be possible. It is then necessary to rotate the parent unit so that it “points” to the child unit.

It is an object of at least the preferred embodiments of the present invention to provide a locating device, system or method which addresses the above disadvantages. Hence at least in its preferred embodiments the present invention seeks to provide a locating technique which enables a user (parent) to determine positional information of a transmitting device with increased reliability and efficiency.

Aspects of the present invention are defined in the independent claims.

Preferred features are as set out in the dependent claims.

Some preferred embodiments of the invention will now be described by way of example only and with reference to the accompanying drawings in which:

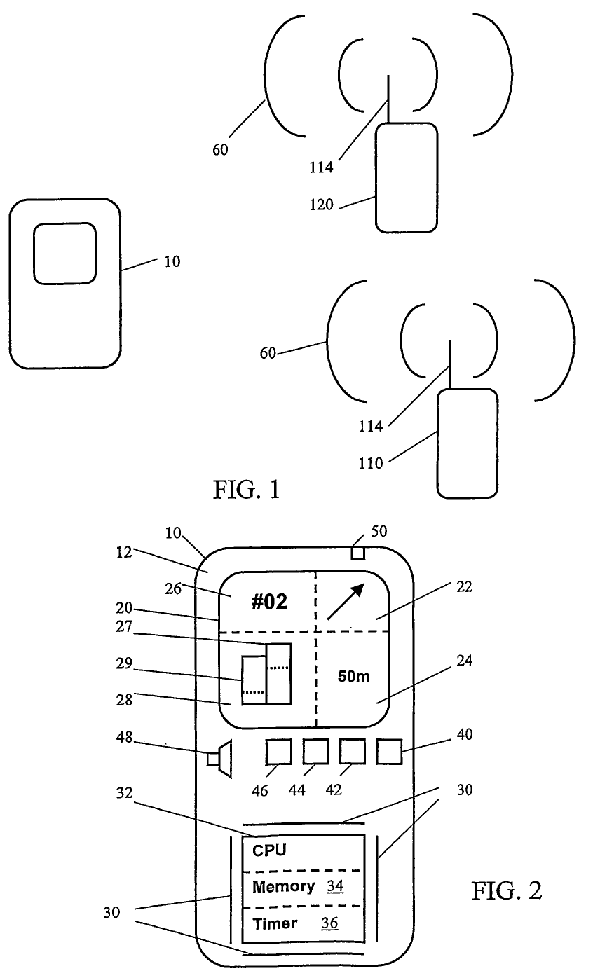

FIG. 1 schematically shows a locating system according to an embodiment of the present invention;

FIG. 2 shows details of a locating device according to the present invention;

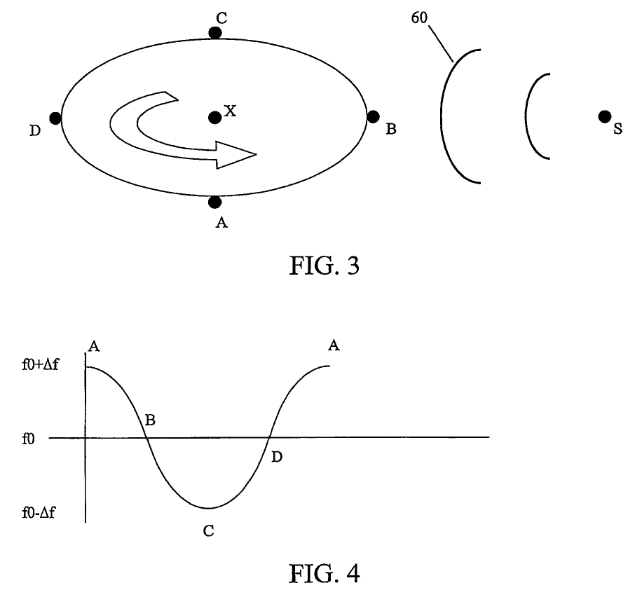

FIG. 3 illustrates the principles of the Dopplescant effect; and

FIG. 4 shows a frequency diagram obtainable by the Dopplescant effect.

The system shown in FIG. 1 comprises a parent unit 10 and two child units 110 and 120. Both child units are able to transmit electromagnetic signals 60 towards the parent unit by means of antenna 114. Although shown as external, antenna 114 is preferably incorporated into the body of the child units.

Referring now to FIG. 2, the parent unit 10 comprises a body 12 on which is mounted a display 20. The parent unit 10 further comprises a processing unit 32 and four antennas 30. The four antennas are sheet antennas which extend into the paper plane of FIG. 2 and are typically a few centimetres wide and long. Each antenna plane is oriented at 90° to the planes of neighbouring antennas so that they are approximately arranged around a square.

Each antenna is a unidirectional antenna, the angular range covered by each antenna being somewhat more than 90°, e.g. 120°, so that the angular ranges covered by neighbouring antennas overlap.

Embodiments of the present invention make use of the “Dopplescant effect”. Whilst this effect is well known, it is believed that no personal locating device exists which makes use of the Dopplescant effect, and therefore its principles are briefly outlined here. The Dopplescant effect can be observed with at least three spaced antennas, but for simplicity the principle will be explained using an arrangement of four antennas.

It is well known that the frequency of a signal as received by a moving receiver depends on its relative speed towards or away from the source of the signal (the Doppler effect). For a receiver moving along a circular path as indicated in FIG. 3 the frequency of signal 60 as perceived by the moving receiver will oscillate between a minimum value of f₀−Δf and a maximum value of f₀+Δf around the true frequency f₀ of the signal 60. FIG. 4 shows a graph of the perceived frequency versus time, i.e. as the moving receiver passes through points A, B, C and D shown in FIG. 3. This illustrates one example of the well-known Doppler effect.

Pursuant to the invention the Dopplescant effect can be observed with an antenna arrangement as that included in the parent unit shown in FIG. 2. FIGS. 3 and 4 are here also used to illustrate the Dopplescant effect. The points A, B, C and D denote the centre points of the four static antennas 30 of the parent unit. During reception operation the four antennas are switched sequentially, with temporal overlap between adjacent antennas, i.e. first only antenna A is switched for reception, then A and B, then B only, then B and C, then C only etc. This sequential switching of four static antennas simulates the circular movement of a single moving antenna, and a frequency shift can be observed, as with the Doppler effect. This phenomenon is used, according to the invention, to determine the direction of the child unit.

Assuming the signal source S is located on a straight line through points B and D and is to the right of point B (as shown in FIG. 3) then the perceived frequency is highest when only antenna A is receiving, and lowest when only antenna C is receiving. Through appropriate processing of the signal as received by the four antennas it can be determined that the signal source S is in the direction of antenna B (with respect to the “axis of rotation” X. In other words, considering the timing diagram shown in FIG. 4, by detecting negative going zero-crossings of the perceived frequency of signal 60 one can determine the antenna which is closest to the signal source S (or which indicates the direction of the signal source S).

The operation of a first embodiment of the present invention (with only one child unit 110) is as follows. The child unit 110 constantly transmits a signal 60, inter alia towards the parent unit 10. The four antennas 30 of the parent unit are switched under the control of CPU 32 as described above, i.e. according to the sequence A, A+B, B, B+C etc. In embodiments of the present invention the direction of the signal source, i.e. child unit 110, is determined as outlined above. CPU 32 outputs this positional information by instructing display 20 to indicate the approximate direction within region 22 on display 20. This indication of direction can take the form of an arrow which can assume eight different directions, corresponding to the direction of each of the four antennas, and the four directions between two adjacent antennas.

According to a second embodiment the distance between the child unit 110 and the parent unit 10 is also estimated. In the second embodiment the direction determination according to the first embodiment is carried out first. Thereafter that antenna or those antennas which are closest to the child unit 110 are used for estimating the distance. If the child unit 110 has been determined as being located within the range of e.g. antenna A only, then only this antenna will be used for distance estimation. If the child unit 110 has been determined as being located within the overlap between the angular ranges of e.g. antennas A and B, then those are used.

In order to estimate the distance the CPU 32 causes the relevant antenna(s) to transmit a distance estimation signal towards the child unit 110. On transmission of this distance estimation signal the CPU 32 starts timer 36 running. The distance estimation signal is detected by child unit 110, which in response transmits a response signal towards the parent unit 10. The return signal is detected by the relevant antenna(s), and on receipt of the return signal the CPU 32 stops timer 36. In other words, timer 36 measures the time that the signals have taken to travel from the parent unit to the child unit and back to the parent unit, plus any processing delays. The measured time is processed by CPU 32 so as to eliminate the processing delays, and so as to estimate the distance between the parent unit 10 and the child unit 110, using standard mathematics. The result is displayed on display 20 in distance indication region 24.

According to a third embodiment, which can be based on either the first or second embodiment, the locating system comprises parent unit 10 and two or more child units 110 and 120, as shown in FIG. 1. The principle of operation of the direction determination and/or distance estimation is the same as in the first and second embodiment. However, in order to enable the parent unit 10 to distinguish between the signals 60 received from different child units each child unit transmits electromagnetic signals with a particular signature associated with that child unit. This signature can be included in the signal 60 by any suitable modulation technique, but it is preferred that a 24 or 32 bit frequency modulated signature is employed. Using a 24 bit signature generates 16 million unique codes, which makes each child unit unique for all practical purposes. This ensures that the parent unit will only respond to a particular child unit. To this end the parent unit includes a memory 34 for storing the signature of one or more child units. The CPU 32 is then able to compare the signature of a received signal with the signature stored in the memory 34. Buttons 42 and 44 are provided on parent unit 10 for selecting a particular one of the child units, and the direction of only this child unit is indicated on display 20.

The signature can be pre-stored in memory 34. Alternatively, the parent unit can be “taught” the signature of one or more child units. To this end, buttons 42 and 44 can be used by the parent to select a particular child unit (a corresponding number is then displayed in region 26 on display 20). In order to teach the parent unit 10 the signature of a particular child unit the two units can be connected by cable via connector 50 (a corresponding connector is provided on the child unit), and a “learn button” 46 is depressed on the parent unit after connection of the two units. On depression of this button the child unit informs the parent unit of its signature via the cable connection.

In a further development it is possible to display the direction and/or distance for several child units simultaneously, for example using different colours to distinguish between the different child units.

The fourth embodiment can again be based on any of the first to third embodiments. The parent unit according to the fourth embodiment additionally has a display region 28 for displaying the battery charging level 27 of the parent unit and/or also the battery charging level 29 of one or more child units. Information about the battery charging level of the child unit is transmitted within the signal sent from child unit 110 to parent unit 10.

Operation of the fifth embodiment of the present invention is again based on any of the first to fourth embodiments. However, according to the fifth embodiment the child unit(s) do/does not continuously transmit signal 60. Instead, child unit 110 transmits signal 60 only on receipt of an initial signal from the parent unit 10. This initial signal would typically only be transmitted when the parent has lost eye contact with the child. The initial signal can, for example, be transmitted on depression of the “on” key 40 on the parent unit, and each time a different child unit is selected by means of keys 42 and 44 (in case two or more child units are used).

The sixth embodiment is again based on any of the first to fifth embodiments. However, the parent unit 10 of the sixth embodiment additionally has for example a load speaker 48 for alerting the parent in case the distance between the parent unit and a child unit has become greater than a predetermined distance (which may be selected by the parent, or fixed).

Additionally, or alternatively, the loud speaker 48 can also be used to alert the parent if no signal 60 is received from the child unit 110.

The seventh embodiment can be based on any of the previous embodiments where more than one child unit is present. According to the seventh embodiment the parent unit cyclically “interrogates” all child units, sequentially. That is, for each child unit the following sequence is performed:
1. transmission of an initial signal from the parent unit to a child unit.
2. transmission of the signal 60 from the child unit to the parent unit for direction determination.
3. (optional) transmission of the distance estimation signal from the parent unit to the child unit and transmission of the return signal from the child unit to the parent unit for distance estimation.

In step 1. above the initial signal transmitted from the parent unit to the child unit is preferably also coded with a particular signature to which only one particular child unit responds.

Although the invention has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims.

1. A child locating system comprising a child locating device, and a further device carried or worn by a child, the further device comprising transmission means for transmitting an electromagnetic signal towards said child locating device,
said child locating device comprising:
at least three spaced antennas for receiving said electromagnetic signal;
switching means for switching the at least three antennas in such a way as to obtain a Dopplescant effect;
processing means for processing the electromagnetic signal as received by the antennas; and
outputting means for producing an output indicative of the direction of the further device with respect to said child locating device.

2-12. (canceled)

13. A locating device for use in a locating system comprising said locating device and a further device, the further device comprising transmission means for transmitting an electromagnetic signal towards said locating device, the electromagnetic signal having a signature associated with the further device;
said locating device comprising:
signature storage means for storing a representation of the signature of the further device;
at least three spaced antennas for receiving said electromagnetic signal;
switching means for switching the at least three antennas in such a way as to obtain a Dopplescant effect;
processing means for processing the electromagnetic signal as received by the antennas so as to detect the signature of the received signal, and to compare the signature as detected with the representation of the signature as stored;
and outputting means for producing, if the signature as detected corresponds to the representation of the signature as stored, an output indicative of the direction of the further device with respect to said locating device.

14. A locating device according to claim 13, comprising at least four spaced antennas.

15. A locating device according to claim 13, wherein the antennas are unidirectional antennas and the angular ranges covered by neighbouring antennas overlap.

16. A locating device according to claim 13, further comprising distance determining means for determining the distance between the locating device and the further device, wherein the locating device is arranged to produce an output indicative of the distance between the locating device and the further device.

17. A locating device according to claim 16, wherein the distance determining means comprises means for causing one of said antennas to transmit a further electromagnetic signal towards the further device, means for causing one of said antennas to receive a return signal from the further device, time measuring means for measuring the time between transmission of the further signal and receipt of the return signal, and estimating means for estimating the distance between the locating device and the further device based on the measured time.

18. A locating device according to claim 17, wherein the means for causing one of said antennas to transmit the further signal is arranged to cause that antenna which is closest to the further device to transmit the further signal.

19. A locating device according to claim 16, wherein the outputting means comprises a display for displaying the direction of the further device with respect to the locating device.

20. A locating device according to claim 19, wherein the display is further arranged to display the distance between the locating device and the further device.

21. A locating device according to claim 16, further comprises notifying means for notifying a user if the distance between the locating device and the further device is larger than a predetermined value.

22. A locating device according to claim 13, further comprising means for alerting a user if no electromagnetic signal is received from the further device.

23. A locating device according to claim 13, further comprising means for causing one of said antennas to transmit an initial electromagnetic signal which is arranged to cause the further device to transmit said electromagnetic signal.

24. A locating device according to claim 13, arranged to communicate with two or more said further devices, wherein the signature storage means is arranged to store the signatures of each further device, the signatures of each further device being different, and wherein the outputting means is arranged to produce an output indicative of the direction and/or the distance of each further device with respect to the locating device.

25. A locating device according to claim 24, wherein the outputting means is arranged to produce simultaneously for each further device an output indicative of the direction and/or the distance with respect to the locating device.

26. A locating device according to claim 24, further comprising means for enabling a user to select a said further device, and wherein the outputting means produces an output indicative of the direction and/or the distance for the selected further device with respect to the locating device.

27. A locating device according to claim 13, wherein the locating device is arranged to receive battery charging level information from the or each further device, and the outputting means is arranged to produce an output indicative of the battery charging level of the or each further device, based on the battery charging level information.

28. A locating system comprising the locating device according to claim 13, and wherein said system includes one or more of said further devices.

29. A locating system according to claim 28, wherein a said further device is arranged to be carried or worn by a person, preferably a child.

30. (canceled)

31. A method of determining, using a locating device, information indicative of the direction of a further device with respect to said locating device, the method comprising:
storing a representation of a signature associated with the further device in said locating device;
transmitting an electromagnetic signal from the further device towards said locating device, the electromagnetic signal including the signature associated with the further device;
receiving said electromagnetic signal at said locating device, using at least three spaced antennas which are switched in such a way as to obtain a Dopplescant effect;
processing the electromagnetic signal as received by the antennas so as to detect the signature of the received signal;
comparing the signature as detected with the representation of the signature as stored; and
if the signature as detected corresponds to the representation of the signature as stored, producing an output indicative of the direction of the further device with respect to said locating device.

32-47. (canceled)

48. A method according to claim 31, wherein the further device is carried or worn by a person, preferably a child.
